(19) United States
(12) Patent Application Publication
(10) Pub. No.: US 2024/0243948 A1
(43) Pub. Date: Jul. 18, 2024

(54) METHOD AND APPARATUS FOR COMPENSATING DOPPLER FREQUENCY IN COMMUNICATION SYSTEM

(71) Applicant: ELECTRONICS AND TELECOMMUNICATIONS RESEARCH INSTITUTE, Daejeon (KR)

(72) Inventors: Woo Ram SHIN, Daejeon (KR); Kyeong Pyo KIM, Daejeon (KR); Young Jo KO, Daejeon (KR); Kap Seok CHANG, Daejeon (KR)

(73) Assignee: ELECTRONICS AND TELECOMMUNICATIONS RESEARCH INSTITUTE, Daejeon (KR)

(21) Appl. No.: 18/400,247

(22) Filed: Dec. 29, 2023

(30) Foreign Application Priority Data
Dec. 29, 2022 (KR) 10-2022-0189657

(51) Int. Cl. H04L 25/02; H04L 5/00; H04L 27/26

(52) U.S. Cl. CPC H04L 25/0228; H04L 5/0012; H04L 27/26532

(57) ABSTRACT

A method of a receiver, which relates to a Doppler frequency compensation technique in a communication system, may comprise: performing a demodulation process so that a fractional part of a Doppler shift of a received signal is compensated; and de-spreading the received signal for which the fractional part of the Doppler shift compensated from a first two-dimensional domain to a second two-dimensional domain.

### CROSS-REFERENCE TO RELATED APPLICATIONS

This application claims priority to Korean Patent Application No. 10-2022-0189657, filed on Dec. 29, 2022, with the Korean Intellectual Property Office (KIPO), the entire contents of which are hereby incorporated by reference.

### BACKGROUND

### 1. Technical Field

The present disclosure relates to a technique for Doppler frequency compensation in a communication system, and more specifically, to a Doppler frequency compensation technique in a communication system, which compensates for a Doppler shift occurring in a time-frequency domain spreading-based signal modulation/demodulation scheme.

### 2. Related Art

With the development of information and communication technology, various wireless communication technologies have been developed. Typical wireless communication technologies include Long Term Evolution (LTE) and New Radio (NR), which are defined in the 3rd Generation Partnership Project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., New Radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, in 6G communication, which is currently being discussed, requirements of mobility support may increase up to 1000 km/h. In order to overcome the vulnerability to Doppler shifts of the existing orthogonal frequency division multiplexing (OFDM) modulation scheme, an orthogonal time frequency space (OTFS) modulation scheme in which a signal is transmitted by applying spreading in the time and frequency domain has been proposed as a candidate technology for a new waveform.

In the OTFS modulation scheme, due to a finite time domain spread length, a Doppler shift of each channel path may not be accurately aligned with a Doppler resource sampled from resources in the delay-Doppler domain or an integer part thereof. Accordingly, an original channel component or channel coefficient may be distributed to Doppler resources other than a Doppler resource closest to the Doppler shift. Such dispersion to other Doppler resources may cause dissipation of the magnitude, power, or energy of the corresponding channel components. For good channel equalization performance, these distributed channel components should be estimated with a small error.

However, the magnitudes of the channel components distributed to the respective Doppler resources may be smaller as a distance from the Doppler resource closest to the Doppler shift increases. In particular, as the Doppler shift is located closer to a center of an interval between Doppler resources, attenuation in the Doppler resource closest to the Doppler shift may increase, and leakage to other Doppler resources may also increase. In addition, in case of channel paths for which a fractional part of a Doppler shift exists, as the channels are distributed to Doppler resources thereof, a phenomenon in which distributed channel components of the respective channel paths are combined may occur in all Doppler resources. These phenomena may deteriorate channel estimation performance for output delay-Doppler resources, and accordingly, channel equalization performance may also deteriorate.

### SUMMARY

Exemplary embodiments of the present disclosure are directed to providing a method and an apparatus for Doppler frequency compensation in a communication system, which compensate for a Doppler shift occurring in a time-frequency domain spreading-based signal modulation/demodulation scheme.

According to a first exemplary embodiment of the present disclosure, a method of a receiver may comprise: performing a demodulation process so that a fractional part of a Doppler shift of a received signal is compensated; and de-spreading the received signal for which the fractional part of the Doppler shift compensated from a first two-dimensional domain to a second two-dimensional domain.

The performing of the demodulation process so that the fractional part of the Doppler shift of the received signal is compensated may include: performing multi-carrier demodulation on multi-carrier symbols of the received signal; de-mapping spread data symbols from resources for the multi-carrier-demodulated multi-carrier symbols in the first two-dimensional domain; and compensating for the fractional part of the Doppler shift for each of the spread data symbols to generate each spread data symbol for which the fractional part of the Doppler shift is compensated.

The performing of the demodulation process so that the fractional part of the Doppler shift of the received signal is compensated may include: performing multi-carrier demodulation on multi-carrier symbols of the received signal; compensating for the fractional part of the Doppler shift for each of the multi-carrier-demodulated multi-carrier symbols to generate each multi-carrier symbol for which the fractional part of the Doppler shift is compensated; and obtaining each spread data symbol for which the fractional part of the Doppler shift is compensated from resources for the multi-carrier symbols for which the fractional part of the Doppler shift is compensated in the first two-dimensional domain.

The method may further comprise: receiving a reference signal from a transmitter; and estimating the fractional part of the Doppler shift based on the reference signal, wherein in the performing of the demodulation process so that the fractional part of the Doppler shift of the received signal is compensated, the receiver compensates for the fractional part of the Doppler shift by using the estimated fractional part of the Doppler shift.

The method may further comprise: transmitting a reference signal to a transmitter; receiving, from the transmitter, information on the fractional part of the Doppler shift estimated based on the reference signal, wherein in the performing of the demodulation process so that the fractional part of the Doppler shift of the received signal is compensated, the receiver compensates for the fractional part of the Doppler shift by using the information on the fractional part of the Doppler shift estimated based on the reference signal, which is received from the transmitter.

The method may further comprise: obtaining data symbols by de-mapping data symbols de-spread from resources in the second two-dimensional domain; performing channel estimation on the data symbols in a delay-Doppler domain; and performing channel equalization on the data symbols based on the channel estimation.

The first two-dimensional domain may correspond to a time-frequency domain, and the second two-dimensional domain may correspond to a delay-Doppler domain.

According to a second exemplary embodiment of the present disclosure, a method of a transmitter may comprise: mapping data symbols to resources in a first two-dimensional domain; spreading the data symbols to resources in a second two-dimensional domain so that a fractional part of a Doppler shift for the data symbols is compensated; and performing multi-carrier modulation on each multi-carrier symbol for the spread data symbols.

The spreading of the data symbols to resources in the second two-dimensional domain so that the fractional part of the Doppler shift for the data symbols is compensated may include: performing preprocessing on the data symbols; compensating for the fractional part of the Doppler shift for the preprocessed data symbols; and mapping the data symbols for which the fractional part of the Doppler shift is compensated to the resources in the second two-dimensional domain.

The spreading of the data symbols to resources in the second two-dimensional domain so that the fractional part of the Doppler shift for the data symbols is compensated may include: performing preprocessing on the data symbols; mapping the preprocessed data symbols to the resources in the second two-dimensional domain; and compensating for the fractional part of the Doppler shift for the data symbols mapped to the resources in the second two-dimensional domain after the preprocessing.

The method may further comprise: receiving a reference signal from a receiver; and estimating the fractional part of the Doppler shift based on the reference signal, wherein in the spreading of the data symbols to resources in the second two-dimensional domain so that the fractional part of the Doppler shift for the data symbols is compensated, the transmitter compensates for the fractional part of the Doppler shift by using the estimated fractional part of the Doppler shift.

The method may further comprise: transmitting a reference signal to a receiver; and receiving, from the receiver, information on the fractional part of the Doppler shift, which is estimated based on the reference signal, wherein in the spreading of the data symbols to resources in the second two-dimensional domain so that the fractional part of the Doppler shift for the data symbols is compensated, the transmitter compensates for the fractional part of the Doppler shift by using the information on the estimated fractional part of the Doppler shift, which is received from the receiver.

The first two-dimensional domain may correspond to a time-frequency domain, and the second two-dimensional domain may correspond to a delay-Doppler domain.

According to a third exemplary embodiment of the present disclosure, a receiver may comprise a processor, and the processor may cause the receiver to perform: performing a demodulation process so that a fractional part of a Doppler shift of a received signal is compensated; and de-spreading the received signal for which the fractional part of the Doppler shift compensated from a first two-dimensional domain to a second two-dimensional domain.

In the performing of the demodulation process so that the fractional part of the Doppler shift of the received signal is compensated, the processor may cause the receiver to perform: performing multi-carrier demodulation on multi-carrier symbols of the received signal; obtaining spread data symbols from resources for the multi-carrier-demodulated multi-carrier symbols in the first two-dimensional domain; and compensating for the fractional part of the Doppler shift for each of the spread data symbols to generate each spread data symbol for which the fractional part of the Doppler shift is compensated.

In the performing of the demodulation process so that the fractional part of the Doppler shift of the received signal is compensated, the processor may cause the receiver to perform: performing multi-carrier demodulation on multi-carrier symbols of the received signal; compensating for the fractional part of the Doppler shift for each of the multi-carrier-demodulated multi-carrier symbols to generate each multi-carrier symbol for which the fractional part of the Doppler shift is compensated; and obtaining each spread data symbol for which the fractional part of the Doppler shift is compensated from resources for the multi-carrier symbols for which the fractional part of the Doppler shift is compensated in the first two-dimensional domain.

The processor may cause the receiver to perform: receiving a reference signal from a transmitter; and estimating the fractional part of the Doppler shift based on the reference signal, wherein in the performing of the demodulation process so that the fractional part of the Doppler shift of the received signal is compensated, the processor further causes the receiver to compensate for the fractional part of the Doppler shift by using the estimated fractional part of the Doppler shift.

The first two-dimensional domain may correspond to a time-frequency domain, and the second two-dimensional domain may correspond to a delay-Doppler domain.

According to the present disclosure, a transmitter or receiver can detect or estimate a fractional part of a Doppler shift, and compensate for it. In addition, according to the present disclosure, the transmitter or receiver can alleviate dispersion of channels in the Doppler domain. Further, according to the present disclosure, the transmitter or receiver can improve channel equalization performance by improving channel estimation performance in the delay-Doppler domain, thereby ultimately improving a block error rate (BLER), bit error rate (BER), throughput, frequency efficiency, transmission speed, and the like.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a flowchart illustrating a first exemplary embodiment of an orthogonal time frequency space (OTFS) modulation method.

FIG. 4 is a flowchart illustrating a first exemplary embodiment of an OTFS demodulation method.

FIG. 5 is a flowchart illustrating a first exemplary embodiment of a Doppler frequency compensation method in a communication system.

FIG. 6 is a flowchart illustrating a second exemplary embodiment of a Doppler frequency compensation method in a communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

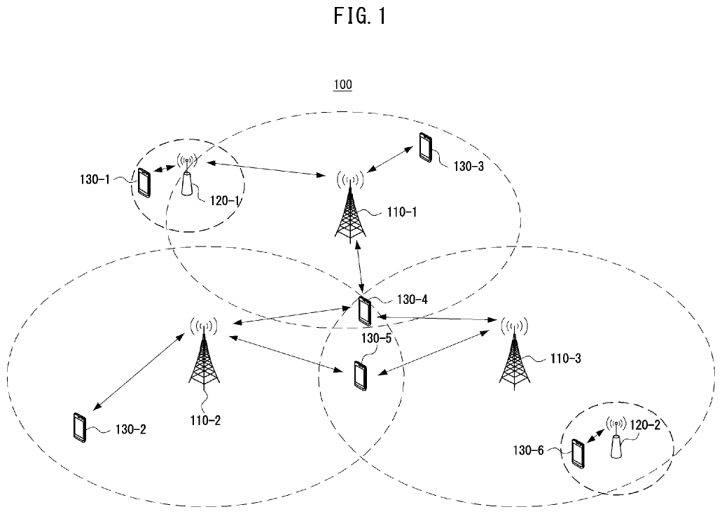

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

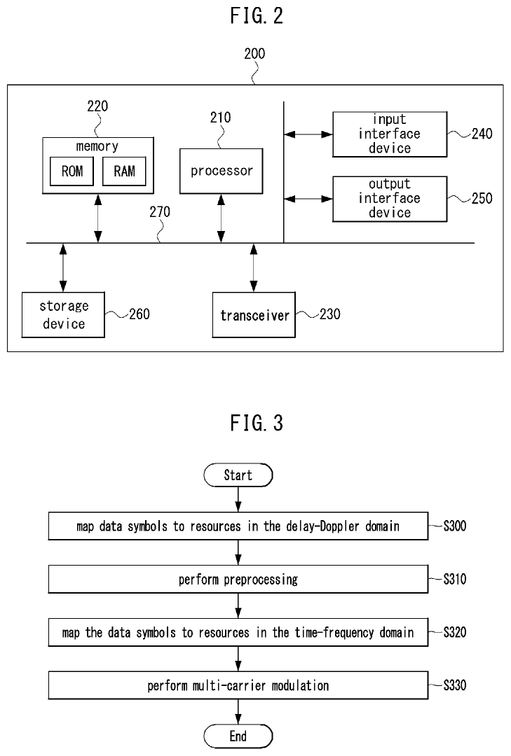

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, in 6G communication, which is currently being discussed, requirements of mobility support may increase up to 1000 km/h. In order to overcome the vulnerability to Doppler shifts of the existing orthogonal frequency division multiplexing (OFDM) modulation scheme, an orthogonal time frequency space (OTFS) modulation scheme in which a signal is transmitted by applying spreading in the time and frequency domain has been proposed as a candidate technology for a new waveform.

A transmitter using the OTFS modulation scheme may map data symbols in the delay-Doppler domain, and spread the data symbols to resources in the time-frequency domain. Here, spreading may refer to a process of preprocessing signals and mapping the preprocessed signals to resources in the time-frequency domain.

For the spread data symbols, the transmitter may perform multi-carrier modulation (e.g., OFDM modulation) for each multi-carrier (MC) symbol. Then, the transmitter may convert the multi-carrier-modulated signal into an analog signal through a digital-to-analog converter (DAC). The transmitter may generate an RF analog signal through a transmitter-side radio frequency (RF) front-end (RFFE), and transmit the RF analog signal through antenna(s). The DAC and the transmitter-side RFFE may be collectively referred to as a transmitter-side transceiver unit, and may be abbreviated as a transmitter-side TXRU.

Meanwhile, a receiver may receive the RF analog signal from the transmitter through antenna(s). The receiver may pass the received RF analog signal through a receiver-side RFFE, and then convert the received RF analog signal into a digital signal through an analog-to-digital converter (ADC). The receiver may perform a demodulation process on the digital signal in the digital baseband. The ADC and the receiver-side RFFE may be collectively referred to as a receiver-side TXRU.

In the digital baseband demodulation process, the receiver may perform multi-carrier demodulation (e.g., OFDM demodulation) for MC symbols, and then de-map the MC symbols from resources in the time-frequency domain. Then, the receiver may de-spread the de-mapped symbols into the delay-Doppler domain through post-processing. Then, the receiver may perform de-mapping from resources in the delay-Doppler domain. The receiver may detect data symbols (or bits constituting the data symbols) by performing delay-Doppler domain channel estimation and channel equalization based on a channel estimate with respect to the de-mapped data symbols.

An encoding system of the receiver may obtain log-likelihood ratio (LLR) values for the encoded bits through the data symbol de-mapping process, and obtain information (or message) bits through a channel decoding process. The receiver may perform the channel equalization before delay-Doppler domain de-mapping, or before or after time-frequency domain de-mapping.

In addition to OTFS, the present disclosure may also consider a modulation scheme that spreads data to each of a plurality of spreading resource groups (or blocks) composed of a plurality of different resources in the time-frequency domain. Hereinafter, such modulation scheme may be collectively referred to as a multi-block spread multi-carrier (MBS-MC) modulation scheme. In such scheme, the present disclosure may consider a fractional Doppler for resources in the delay-Doppler domain, which corresponds to each spreading resource group.

Due to a finite time domain spread length, a Doppler shift of each channel path may not be accurately aligned with a Doppler resource sampled from resources in the delay-Doppler domain or an integer part thereof. Accordingly, an original channel component or channel coefficient may be distributed to Doppler resources other than a Doppler resource closest to the Doppler shift. Such the dispersion to other Doppler resources may cause dissipation of the magnitude, power, or energy of the corresponding channel components.

For good channel equalization performance, these distributed channel components should be estimated with a small error. However, the magnitudes of the channel components distributed to the respective Doppler resources may be smaller as a distance from the Doppler resource closest to the Doppler shift increases. In particular, as the Doppler shift is located closer to a center of an interval between Doppler resources, attenuation in the Doppler resource closest to the Doppler shift may increase, and leakage to other Doppler resources may also increase. In addition, in case of channel paths for which a fractional part of a Doppler shift exists, as the channels are distributed to Doppler resources thereof, a phenomenon in which distributed channel components of the respective channel paths are combined may occur in all Doppler resources.

These phenomena may deteriorate channel estimation performance for output delay-Doppler resources, and accordingly, channel equalization performance may also deteriorate. The present disclosure provides a method of estimating a fractional part of a Doppler shift for a channel path having the greatest magnitude and a fractional part of a Doppler shift having the greatest influence due to a complex influence caused by fractional parts of Doppler shifts of a plurality of channel paths, and a compensation method therefor.

Meanwhile, the OTFS modulation scheme may have a single resource grid in the delay-Doppler domain. In addition, the MBS-MC modulation scheme may define an independent delay-Doppler domain resource grid for each spreading resource group for spreading to different resource(s) in the time-frequency domain. The resource grid may refer to a multi-dimensional resource structure composed of one or more resources (or resource elements). For example, the resource grid in the delay-Doppler domain may refer to a structure in which resource elements are arranged in two dimensions on the delay axis and the Doppler axis.

Here, a delay-Doppler resource may refer to a resource belonging to the delay-Doppler domain. A Doppler (or delay) resource may refer to a resource belonging to the Doppler (or delay) domain. A delay-Doppler resource may be indicated by a delay-Doppler resource index. The delay-Doppler resource may be expressed in one dimension. Alternatively, the delay-Doppler resource may be expressed in two dimensions by using a delay resource index and a Doppler resource index. The ‘delay-Doppler resource’ may be replaced by a term ‘Doppler-delay resource’, and the ‘delay-Doppler domain’ may be replaced by a term ‘Doppler-delay domain’. However, hereinafter, they are described based on the terms ‘delay-Doppler resource’ and ‘delay-Doppler region’, respectively. Each column of an effective channel matrix in the delay-Doppler domain, which will be described later, may correspond to each input delay-Doppler resource, and each row thereof may correspond to each output delay-Doppler resource.

A time-frequency resource may refer to a resource belonging to the time-frequency domain. A time (or frequency) resource may refer to a resource belonging to the time (or frequency) domain. A time-frequency resource may be indicated by a time-frequency resource index. The time-frequency resource may be expressed in one dimension, or may be expressed in two dimensions by using a time resource index and a frequency resource index. The ‘time-frequency resource’ may be replaced by a term ‘frequency-time resource’, and the ‘time-frequency domain’ may be replaced by a term ‘frequency-time domain’. However, hereinafter, they are described based on the terms ‘time-frequency resource’ and ‘time-frequency domain’, respectively.

The delay-Doppler domain has duality with the time-frequency domain in signal analysis. In order to prevent the ideas and techniques of the present disclosure from being interpreted as limited due to the use of specific terms such as delay-Doppler domain and time-frequency domain and thus preventing evasion of the ideas and techniques of the present disclosure, the delay-Doppler domain may be generalized to a first two-dimensional domain, and the time-frequency domain may be generalized to a second two-dimensional domain. Accordingly, the delay-Doppler domain described later may be replaced with the first two-dimensional domain, and a delay-Doppler resource may be replaced with a first two-dimensional resource. In addition, the delay resource and Doppler resource may be replaced with a first resource in the first two-dimensional domain and a second resource in the first two-dimensional domain, respectively. Further, the time-frequency domain described later may be replaced with the second two-dimensional domain, and the time-frequency resource may be replaced with a second two-dimensional resource. Further, the time resource and the Doppler resource may be replaced with a first resource in the second two-dimensional domain and a second resource in the second two-dimensional domain, respectively.

The present disclosure describes a method of compensating for a fractional part of a Doppler shift and a method of estimating the fractional part of the Doppler shift. First, the present disclosure describes a modulation scheme and a demodulation scheme to which they are applicable. In addition, the present disclosure makes description based on the OTFS, which spreads across all resources in the time-frequency domain, as an example of modulation. Meanwhile, the method of compensating for a fractional part of a Doppler shift and a method of estimating the fractional part of the Doppler shift, which will be described later, may be applied identically or similarly to the scheme (or MBS-MC scheme) based on spreading to some resources in the time-frequency domain.

Specifically, the method of compensating a fractional part of a Doppler shift and the method of estimating the fractional part of the Doppler shift, which are applied to the OTFS scheme considered to have a single delay-Doppler resource grid, may be applied identically or similarly to ‘each spreading resource group (or block)’ or ‘each delay-Doppler resource grid’ of the MBS-MS scheme.

FIG. 3 is a flowchart illustrating a first exemplary embodiment of an orthogonal time frequency space (OTFS) modulation method.

Referring to FIG. 3, a transmitter may map data symbols (i.e., data symbols constituting a codeword) to resources in the delay-Doppler domain (S300). The transmitter may preprocess the data symbols (S310) and map the preprocessed data symbols to resources in the time-frequency domain (S320). In the above-described manner, the transmitter may spread the data symbols to resources in the time-frequency domain. The spreading may refer to a process of preprocessing signals and mapping the preprocessed signals to resources in the time-frequency domain. For these spread data symbols, the transmitter may perform multi-carrier modulation (e.g., OFDM modulation) for each multi-carrier symbol (S330). Meanwhile, the transmitter may spread each data symbol to some resources in the time-frequency domain. The transmitter may pass the modulated signal output through the modulation process through a transmitter-side TXRU and transmit the converted RF analog signal through antenna(s).

In the above-described OTFS transmission process, when spread to all resources in the time-frequency domain, a digital baseband transmission signal input to the TXRU may be expressed as Equation 1 below.

$$S = {C}_{I} {F}_{M}^{H} {F}_{M} X {F}_{N}^{H} = {C}_{I} X {F}_{N}^{H} \qquad [ Equation 1 ]$$

Here, S may be an OTFS modulated symbol matrix with a size of M̅×N. X may be a data symbol matrix of size M×N for the codeword. F_{K} may be a K-point discrete Fourier transform matrix. C_{I} may be a cyclic prefix (CP) insertion matrix with a CP length of M_{cP}. M̅ may be M+M_{CP}, which is the length of a multi-carrier symbol, expressed as the number of time samples, and may be a real number. M may be the number of carriers or delays in a time-frequency resource or a delay-Doppler resource and may be a real number. M_{CP} may be the CP length, which is expressed as the number of time samples, and may be a real number. N may be the number of multi-carrier symbols or Doppler shifts in a time-frequency resource or delay-Doppler resource and may be a real number. (·)^{H} means a complex conjugate transpose of a given matrix.

Here, each column of S is a transmission signal belonging to each MC symbol, and when S is vectorized, Equation 2 may be obtained. Here, (·)^{T} means a transpose of an input matrix. ⊗ means a Kronecker product operator.

$$s = vec ( S ) = ( {F}_{N}^{H} ⊗ {C}_{I} ) vec ( X ) = ( {F}_{N}^{H} ⊗ {C}_{I} ) x \qquad [ Equation 2 ]$$

Here, vec(S) may be equal to Equation 3 below.

$$vec ( S ) = vec ( [ {s}_{1} {s}_{2} … {s}_{N} ] ) = {[ {s}_{1}^{T} {s}_{2}^{T} … {s}_{N}^{T} ]}^{T} \qquad [ Equation 3 ]$$

Meanwhile, the transmission signal may undergo a multi-path channel. In this case, a reception signal received by a receiver from the transmitter may be expressed as Equation 4 below. Here, r may be a reception signal vector of a reception signal received during a transmission time interval. H may be a channel impulse response matrix during the transmission time interval. n may be a Gaussian noise vector.

$$r = Hs + n \qquad [ Equation 4 ]$$

In Equation 4, the channel response matrix may be given as a sum of channel responses each configured through each channel path, as in Equation 5.

$$H = {\sum }_{p ∈ {[ P ]}^{+}} {η}_{p} \cdot {Π}_{\overline{M} N , {L}_{{CH}^{+ 1}}}^{{τ}_{p}} \cdot {Δ}_{\overline{M} N}^{{v}_{p}} \qquad [ Equation 5 ]$$

P may be the number of channel paths. [K]⁺ may be defined as [K]⁺={1, 2, . . . , K} for K, a positive integer. nₚ may be a channel coefficient of the p-th channel path. Π_{L,L̅} may be expressed as Equation 6 and may be a non-circular row-wise shift (or time translation) matrix with a size of (L+L̅−1)×L.

$${Π}_{L , \overline{L}} ( := [ \begin{matrix}0 & 0 & … & 0 \\ 1 & 0 & ⋱ & 0 \\ 0 & ⋱ & ⋱ & ⋮ \\ 0 & 0 & 1 & 0\end{matrix} ] ) \qquad [ Equation 6 ]$$

Δ_{L} may be a diagonal matrix diag(ξ⁰, ξ¹, . . . , ξ^{L-1}) with a size of L×L, where ξ is defined as ξ:=exp(l2π/L), and may be a frequency modulation matrix. τₚ may be a delay normalized by a delay interval in the delay-Doppler domain, and may be expressed as Equation 7 below. Here, τ̅ₚ may be a delay of the p-th channel path in the time domain. Δf may be a subcarrier spacing. lₚ may be an integer part of the nearest delay sample τₚ in the delay-Doppler domain. lₚ may be a fractional part of the nearest delay sample τₚ in the delay-Doppler domain.

$${τ}_{p} = {\overline{τ}}_{p} M Δ f = {l}_{p} {i}_{p} \qquad [ Equation 7 ]$$

Meanwhile, Vₚ may be equal to Equation 8 below, and may be a Doppler shift normalized by a Doppler interval in the delay-Doppler domain. V̅ₚ may be a Doppler shift of the p-th channel path in the frequency domain. T may be an MC symbol period. kₚ may be an integer part of the nearest Doppler sample in the Doppler-delay domain. kₚ may be a fractional part of the nearest Doppler sample in the Doppler-delay domain. L_{CH} may be the maximum channel length in time samples and may be a positive real number.

$${v}_{p} = {\overline{v}}_{p} NT = {k}_{p} + {κ}_{p} \qquad [ Equation 8 ]$$

Referring to Equation 5, it can be seen that the channel response matrix is composed of three elements for each channel path: delay (or time shift), Doppler shift, and channel coefficient.

The receiver may receive an RF analog signal from the transmitter through antenna(s). The receiver may obtain a digital baseband signal by passing the received RF analog signal through a receiver-side RFFE and converting it into a digital signal. Then, the receiver may perform a demodulation process on the digital baseband signal.

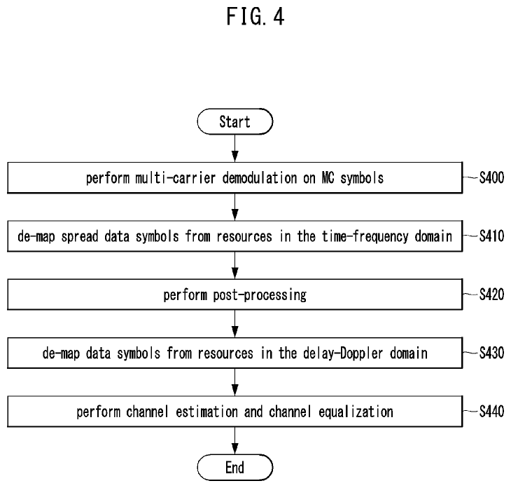

FIG. 4 is a flowchart illustrating a first exemplary embodiment of an OTFS demodulation method.

Referring to FIG. 4, a receiver may perform multi-carrier demodulation on multi-carrier symbols (S400). The receiver may de-map (spread) data symbols from resources in the time-frequency domain (S410). Then, the receiver may de-spread the de-mapped data symbols into the delay-Doppler domain through post-processing (S420). Here, the de-spreading may mean a process of de-mapping the (spread) data symbols from resources in the time-frequency domain and performing post-processing on the de-mapped data symbols. Thereafter, the receiver may obtain de-mapped data symbols by performing de-mapping of data symbols de-spread from resources in the delay-Doppler domain (S430). Then, the receiver may detect data symbols (or bits constituting the data symbols) by performing delay-Doppler domain channel estimation and channel equalization based on the channel estimate for the de-mapped data symbols (S440).

In relation to this, a decoding system of the receiver may calculate LLR values for the encoded bits through the data symbol de-mapping process and obtain information (or message) bits through a channel decoding process. Here, the channel equalization may be performed before delay-Doppler domain de-mapping, or before or after time-frequency domain de-mapping.

In the OTFS reception process, the receiver may perform de-spreading from all resources in the time-frequency domain. In this case, a signal obtained by performing the demodulation process on the digital baseband reception signal output from a TXRU of the receiver before delay-Doppler domain channel estimation and equalization may be expressed as a determinant as shown in Equation 9 below. Here, Y may be a data symbol matrix demodulated from the reception signal matrix R. C_{R} may be equal to C_{I}^{T} and may be a CP removal matrix.

$$Y = {F}_{M}^{H} {F}_{M} {C}_{R} {RF}_{N} = {C}_{R} {RF}_{N} \qquad [ Equation 9 ]$$

Here, each column of Y may be a demodulated data symbol vector belonging to each Doppler resource, and when Y is vectorized, it may be expressed as Equation 10.

$$y = vec ( Y ) = ( {F}_{N} ⊗ {C}_{R} ) vec ( R ) = ( {F}_{N} ⊗ {C}_{R} ) r = ( {F}_{N} ⊗ {C}_{R} ) ( Hs + n ) = ( {F}_{N} ⊗ {C}_{R} ) ( H ( {F}_{N}^{H} ⊗ {C}_{I} ) x + n ) = \overline{H} x + \overline{n} \qquad [ Equation 10 ]$$

In Equation 10, H̅ may be equal to Equation 11 below.

$$\overline{H} = ( {F}_{N} ⊗ {I}_{M} ) ( {I}_{N} ⊗ {C}_{R} ) H ( {I}_{N} ⊗ {C}_{I} ) ( {F}_{N}^{H} ⊗ {I}_{M} ) = ( {F}_{N} ⊗ {I}_{M} ) ( {\sum }_{p ∈ {[ P ]}^{+}} {η}_{p} \cdot {b diag}_{n ∈ {[ N ]}^{+}} ( {Ψ}_{n}^{( p )} ) ) ( {F}_{N}^{H} ⊗ {I}_{M} ) \qquad [ Equation 11 ]$$

In Equation 11,

$${b diag}_{n ∈ {[ N ]}^{+}} ( {Ψ}_{n}^{( p )} )$$

may be equal to Equation 12 below.

$${b diag}_{n ∈ {[ N ]}^{+}} ( {Ψ}_{n}^{( p )} ) = ( {I}_{N} ⊗ {C}_{R} ) {Π}_{\overline{M} N}^{{τ}_{p}} {Δ}_{\overline{M} N}^{{v}_{p}} ( {I}_{N} ⊗ {C}_{I} ) \qquad [ Equation 12 ]$$

In Equation 12, Ψₘ^{(p)} may be equal to Equation 13 below.

$${Ψ}_{n}^{( p )} = {\overline{Π}}_{M}^{{τ}_{p}} {\overline{Δ}}_{M , \overline{M} N , \overline{M} ( n - 1 )}^{{v}_{p}} \qquad [ Equation 13 ]$$

In Equation 13, Π̅_{L} may be equal to Equation 14 below, and may be a circular row-wise shift (or time translation) matrix with a size of L×L.

$${\overline{Π}}_{L} := [ \begin{matrix}0 & … & 0 & 1 \\ 1 & 0 & ⋱ & 0 \\ 0 & ⋱ & ⋱ & ⋮ \\ 0 & 0 & 1 & 0\end{matrix} ] \qquad [ Equation 14 ]$$

Δ̅_{L,L̅l} may be equal to Equation 15 below, and may be a frequency modulation matrix with an offset l and a diagonal matrix with a size of L×L, which has ξ̅=exp(l2π/L̅).

$${\overline{Δ}}_{L , \overline{L} , l} := diag ( {\overline{ζ}}^{l} , {\overline{ζ}}^{l + 1} , … , {\overline{ζ}}^{l + L - 1} ) \qquad [ Equation 15 ]$$

bdiag(Aₙ) may be expressed as Equation 16 below.

n∈[N]⁺

$${b diag}_{n ∈ {[ N ]}^{+}} ( {A}_{n} ) = [ \begin{matrix}{A}_{1} & & & \\ & {A}_{2} & & \\ & & ⋱ & \\ & & & {A}_{N}\end{matrix} ] \qquad [ Equation 16 ]$$

ñ may be equal to Equation 17.

$$\overline{n} = ( {F}_{N} ⊗ {C}_{R} ) n \qquad [ Equation 17 ]$$

Meanwhile, the receiver may compensate for a fractional part of a Doppler shift for a channel path having the largest channel magnitude (or channel coefficient). Alternatively, the receiver may compensate for fractional parts of Doppler shifts for all channel paths. Alternatively, the receiver may compensate for fractional parts of Doppler shifts for some channel paths. Alternatively, the receiver may compensate for a fractional part of a Doppler shift that is most influential. For example, the receiver may compensate for a fractional part of a Doppler shift for a line of sight (LoS) channel path. Hereinafter, the present disclosure describes a method of compensating for a fractional part of a Doppler shift given through a series of processes.

An integer part k of a given Doppler shift frequency v̅ may be expressed as in Equation 18 below when it is based on the location of the nearest Doppler resource.

$$k = ⌊ \overline{v} / {T}_{S} ⌋ \qquad [ Equation 18 ]$$

Here, [·] may be a rounded value for a (real) input value, and Tₛ may be a time domain spread length, which may be a product of the number N of time domain spread MC symbols and an MC symbol length T. Tₛ may be equal to Equation 19.

$${T}_{S} = NT \qquad [ Equation 19 ]$$

Equation 19 may correspond to a case where all MC symbols have the same MC symbol length. An interval of Doppler domain resources may be a reciprocal of the time domain spread length. The integer part of the Doppler shift integer may be based on the location of the nearest Doppler resource. In this case, a fractional part k of the given Doppler shift frequency v may be expressed as Equation 20 below.

$$κ = \overline{v} / {T}_{S} - k \qquad [ Equation 20 ]$$

The fractional part of the Doppler shift may be a real number between −0.5 and 0.5, including −0.5. Hereinafter, the fractional part of the Doppler shift to be compensated may be \hat{k}.

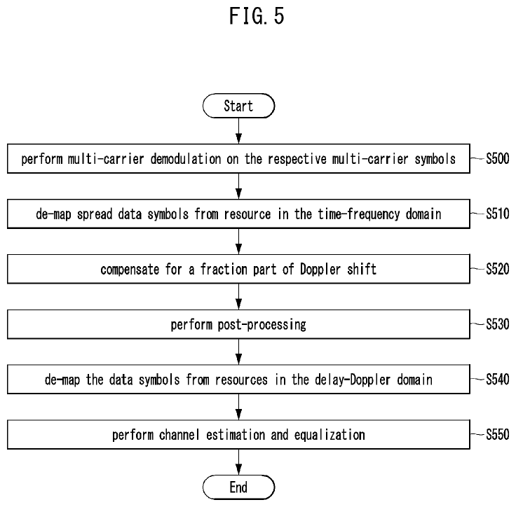

FIG. 5 is a flowchart illustrating a first exemplary embodiment of a Doppler frequency compensation method in a communication system.

Referring to FIG. 5, in the Doppler frequency compensation method, the receiver may perform a demodulation process on a received signal. The received signal may be a digital baseband signal obtained by receiving an RF analog signal from the transmitter through antenna(s), passing the RF analog signal through a receiver-side RFFE, and converting the RF analog signal into a digital signal.

Describing this in more detail, during the demodulation process, the receiver may perform multi-carrier demodulation on multi-carrier symbols (S500). Then, the receiver may obtain data symbols spread (during the modulation process) by de-mapping them from resources for the demodulated multi-carrier symbols in the time-frequency domain (S510). Here, the data symbols spread (during the modulation process) may reflect influences of the channels, and hereinafter, unless otherwise specified, they are referred to as ‘spread data symbols’.

After de-mapping from resources in the time-frequency domain during the reception process, the receiver may compensate for fractional part(s) of Doppler shift(s) using a fractional part phase compensation matrix for the data symbols as shown in Equation 21 below (S520). In other words, the receiver may compensate for the fractional part(s) of Doppler shift(s) using the fractional part phase compensation matrix for the multi-carrier-demodulated multi-carrier symbols.

$$\overline{Y} = {F}_{M}^{H} {F}_{M} {C}_{R} R {Φ}^{\hat{κ}} {F}_{N} = {C}_{R} R {Φ}^{\hat{κ}} {F}_{N} ↔ \tilde{y} = vec ( \tilde{Y} ) = ( ( {F}_{N} {Φ}^{\hat{κ}} ) ⊗ {C}_{R} ) vec ( R ) = \tilde{H} x + \tilde{n} \qquad [ Equation 21 ]$$

Here, Φ may be the fractional part phase compensation matrix, and may be a diagonal matrix such as diag{ϕ⁰, ϕ¹, . . . , ϕ^{N-1}}. In this case, ϕ may be equal to Equation 22 below.

$$ϕ = - ι2π / N \qquad [ Equation 22 ]$$

\tilde{H} may be equal to Equation 23 below.

$$\begin{matrix}\overline{H} & = ( ( {F}_{N} {Φ}^{\hat{κ}} ) ⊗ {I}_{M} ) ( {I}_{N} ⊗ {C}_{R} ) H ( {I}_{N} ⊗ {C}_{I} ) ( {F}_{N}^{H} ⊗ {I}_{M} ) \\ & = ( {F}_{N} ⊗ {I}_{M} ) ( {\sum }_{p ∈ {[ P ]}^{+}} {η}_{p} \cdot {b diag}_{n ∈ {[ N ]}^{+}} ( {ϕ}^{\hat{κ} ( n - 1 )} \cdot {Ψ}_{n}^{( p )} ) ) ( {F}_{N}^{H} ⊗ {I}_{M} ) \\ & = ( {F}_{N} ⊗ {I}_{M} ) ( {b diag}_{n ∈ {[ N ]}^{+}} ( {ϕ}^{\hat{κ} ( n - 1 )} \cdot {\sum }_{p ∈ {[ P ]}^{+}} {η}_{p} \cdot {Ψ}_{n}^{( p )} ) ) ( {F}_{N}^{H} ⊗ {I}_{M} )\end{matrix} \qquad [ Equation 23 ]$$

Here, ϕ^{\hat{R}(n-1)} may be a fractional part phase compensation term of the n-th multi-carrier symbol and may be equal to Equation 24.

$${ϕ}^{\hat{κ} ( n - 1 )} \cdot {Ψ}_{n}^{( p )} = {ϕ}^{\hat{κ} ( n - 1 )} \cdot {\overline{\prod }}_{M}^{{τ}_{p}} {\overline{Δ}}_{M , \overline{M} N , \overline{M} ( n - 1 )}^{{v}_{p}} = {\overline{\prod }}_{M}^{{τ}_{p}} {\overline{Δ}}_{M , \overline{M} N , \overline{M} ( n - 1 ) ( 1 - \hat{κ} )}^{{v}_{p}} \qquad [ Equation 24 ]$$

Here, ñ may be effective noise and may be equal to Equation 25 below.

$$\tilde{n} = ( ( {F}_{N} {Φ}^{\hat{κ}} ) ⊗ {C}_{R} ) n \qquad [ Equation 25 ]$$

The receiver may compensate for the fractional part of Doppler shift by multiplying the received signal R by Φ^{\hat{R}} as shown in Equation 21. Here, the receiver compensates for the fractional part of Doppler shift by multiplication with the diagonal matrix, but it may be replaced with another operation that has the same effect. Here, the compensation of the fractional part of Doppler shift of the n-th MC symbol may compensate for a Doppler frequency corresponding to \hat{k}(n−1)/N.

The above-described process of performing the demodulation process to compensate for the fractional part of Doppler shift for the received signal may include: a step of performing multi-carrier demodulation on the respective multi-carrier symbols of the received signal; a step of obtaining spread data symbols from resources of the demodulated multi-carrier symbols in the time-frequency domain; and a step of compensating for the fractional part of Doppler shift for each spread data symbol to generate each multi-carrier symbol with the fractional part of Doppler shift compensated. Alternatively, the process of performing the demodulation process to compensate for the fractional part of Doppler shift of the received signal may include: a step of performing multi-carrier demodulation on the respective multi-carrier symbols of the digital signal; a step of compensating for the fractional part of Doppler shift for each multi-carrier-demodulated multi-carrier symbol to generate each multi-carrier symbol with the fractional part of Doppler shift compensated; and a step of obtaining spread data symbols with the fractional part of Doppler shift compensated from resources for the multi-carrier symbols with the fractional part of Doppler shift compensated in the time-frequency domain.

Meanwhile, the receiver may de-spread the de-mapped symbols to the delay-Doppler domain through post-processing (S530). Here, the de-spreading may refer to a process of performing de-mapping from resources in the time-frequency domain and then performing post-processing. Thereafter, the receiver may obtain de-mapped data symbols by performing de-mapping of the data symbols de-spread from resources in the delay-Doppler domain (S540). Then, the receiver may detect data symbols (or bits constituting the data symbols) by performing delay-Doppler domain channel estimation and channel equalization based on a channel estimate with respect to the de-mapped data symbols (S550).

An encoding system of the receiver may obtain log-likelihood ratio (LLR) values for the encoded bits through the data symbol de-mapping process, and obtain information (or message) bits through a channel decoding process. The receiver may perform the channel equalization before delay-Doppler domain de-mapping, or before or after time-frequency domain de-mapping.

In the OTFS reception process, the receiver may perform de-spreading from all resources in the time-frequency domain. In this case, a signal obtained by performing the demodulation process on the received signal of the receiver (i.e., the digital baseband reception signal output from the TXRU of the receiver) before delay-Doppler domain channel estimation and equalization may be expressed as a determinant as shown in Equation 9 below.

Meanwhile, as described above, the receiver may perform the compensation for the fractional part of Doppler shift after de-mapping from resources in the time-frequency domain. In this case, the receiver may perform the compensation for the fractional part of Doppler shift for signals of the de-mapped resources. Alternatively, the receiver may perform the compensation for the fractional part of Doppler shift before de-mapping from resources in the time-frequency domain. In this case, the receiver may perform the compensation for the fractional part of Doppler shift for signals of all resources in the time-frequency domain. Alternatively, the receiver may selectively perform the compensation for the fractional part of Doppler shift for signals of some resources in the time-frequency domain.

Meanwhile, the receiver may obtain the fractional part of Doppler shift for the compensation for the fractional part of Doppler shift in the reception process by using the following one or more of two methods.

Method 1: The receiver may directly estimate the fractional part of Doppler shift by using a reference signal for channel estimation/measurement, which is received from the transmitter. Additionally or alternatively, the receiver may directly estimate the fractional part of Doppler shift by using signal(s) of other uses/types or detected/decoded data symbol(s), which are received from the transmitter, in addition to the reference signal for channel estimation/measurement.

Method 2: The transmitter may estimate the fractional part of Doppler shift by using a reference signal for channel estimation/measurement received from the receiver. Additionally or alternatively, the transmitter may directly estimate the fractional part of Doppler shift by using signal(s) of other uses/types or detected/decoded data symbol(s), which are received from the receiver, in addition to the reference signal for channel estimation/measurement. Then, the transmitter may signal (or feedback) the estimated fractional part of Doppler shift to the receiver, and the receiver may obtain the fractional part of Doppler shift by receiving it from the transmitter.

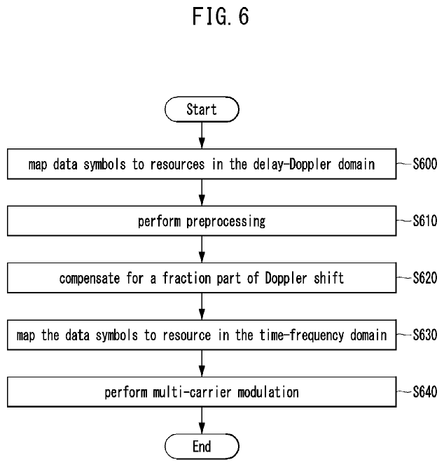

FIG. 6 is a flowchart illustrating a second exemplary embodiment of a Doppler frequency compensation method in a communication system.

Referring to FIG. 6, the transmitter may map data symbols (i.e., data symbols constituting a codeword) to resources in the delay-Doppler domain (S600). In addition, the transmitter may preprocess the data symbols (S610).

The transmitter may perform compensation for a fractional part of Doppler shift in a transmission process of the preprocessed data symbols as shown in Equation 26 (S620).

$$\overline{S} = {C}_{I} {F}_{M}^{H} {F}_{M} X {Φ}^{\hat{κ}} {F}_{N}^{H} = {C}_{I} X {Φ}^{\hat{κ}} {F}_{N}^{H} ↔ \overline{s} = vec ( \overline{S} ) = ( ( {F}_{N}^{H} {Φ}^{\hat{κ}} ) ⊗ {C}_{I} ) vec ( R ) = ( ( {F}_{N}^{H} {Φ}^{\hat{κ}} ) ⊗ {C}_{I} ) x \qquad [ Equation 26 ]$$

The transmitter may compensate for the fractional part of Doppler shift by multiplying a transmission signal X by Φ^{\hat{k}} as shown in Equation 26. Here, the transmitter compensates for the fractional part of Doppler shift by multiplication with the diagonal matrix, but it may be replaced with another operation that produces the same effect.

The above-described process of spreading the data symbols to resource in the time-frequency domain, in performing the modulation process so that the fractional part of Doppler shift is compensated, may include: a step of performing preprocessing on the data symbols; a step of compensating for the fractional part of Doppler shift for the preprocessed data symbols; and a step of mapping the data symbols with the fractional part of Doppler shift compensated to resources in the time-frequency domain. Alternatively, the above-described process of spreading the data symbols to resource in the time-frequency domain, in performing the modulation process so that the fractional part of Doppler shift is compensated, may include: a step of performing preprocessing on the preprocessed data symbols; a step of mapping the preprocessed data symbols to resources in the time-frequency domain; and a step of compensating for the fractional part of Doppler shift for the data symbols mapped to resources in the second two-dimensional domain after the preprocessing.

Meanwhile, the transmitter may map the preprocessed data symbols with the fractional part of Doppler shift compensated to resources in the time-frequency domain (S640). In the above-described manner, the transmitter may spread the data symbols to resources in the time-frequency domain. Here, spreading may mean a process of preprocessing the data symbols and mapping the preprocessed data symbols to resources in the time-frequency domain. For the spread data symbols, the transmitter may perform multi-carrier modulation (e.g., orthogonal frequency division multiplexing (OFDM) modulation) on the respective multi-carrier symbols (S650). On the other hand, the transmitter may spread the data symbols to some resources in the time-frequency domain.

Thereafter, the transmitter may transmit an RF analog signal converted through the transmitter-side TXRU through antenna(s).

On the other hand, the transmitter may perform the compensation for the fractional part of Doppler shift before mapping to resources in the time-frequency domain. In this case, the transmitter may perform the compensation for the fractional part of Doppler shift for signals of all resources in the time-frequency domain. Alternatively, the transmitter may selectively perform the compensation for the fractional part of Doppler shift for signals of some resources in the time-frequency domain. On the other hand, the transmitter may perform the compensation for the fractional part of Doppler shift after mapping to resources in the time-frequency domain. In this case, the transmitter may perform the compensation for the fractional part of Doppler shift for signals of the mapped resources.

Meanwhile, the transmitter may obtain the fractional part of Doppler shift for the compensation for the fractional part of Doppler shift in the transmission process by using the following one or more of two methods.

Method 1: The transmitter may directly estimate the fractional part of Doppler shift by using a reference signal for channel estimation/measurement, which is received from the receiver. Additionally or alternatively, the transmitter may directly estimate the fractional part of Doppler shift by using signals of other uses/types or detected/decoded data symbols, which are received from the receiver, in addition to the reference signal for channel estimation/measurement.

Method 2: The receiver may estimate the fractional part of Doppler shift by using the reference signal for channel estimation/measurement received from the transmitter. Additionally or alternatively, the receiver may directly estimate the fractional part of Doppler shift by using signals of other uses/types or detected/decoded data symbol, which are received from the transmitter, in addition to the reference signal for channel estimation/measurement. Then, the receiver may signal (or feedback) the estimated fractional part of Doppler shift to the transmitter, and the transmitter may obtain the fractional part of Doppler shift by receiving it from the receiver.

On the other hand, the transmitter or receiver may perform Doppler shift compensation for each of given (or selected) fractional part candidates, and then perform delay-Doppler domain channel estimation using a demodulation reference signal. Then, the transmitter or receiver may select a value with the greatest magnitude among channel estimates for channel estimation target (output) delay-Doppler domain resources. The transmitter or receiver may select the greatest fractional part candidate for Doppler shift from the corresponding channel estimate. In the OTFS system that spreads to all resources in the time-frequency domain, the method for the transmitter or receiver to estimate the fractional part of Doppler shift may be expressed as in Equation 27.

$$\hat{K} = \begin{matrix}argmax \\ {kϵS}_{k}\end{matrix} ( \begin{matrix}max \\ {mϵS}_{d} , {nϵS}_{D}\end{matrix} \vert {[ {\hat{H}}_{q}^{( k )} ]}_{m , n} \vert ) \qquad [ Equation 27 ]$$

Here, Sₖ may be a set of candidates for the fractional part of Doppler shift. S_{d} may be a set of delay resources (or resource indices) in the delay-Doppler domain channel estimation. S_{D} may be a set of Doppler resources (or resource indices) in the delay-Doppler domain channel estimation. Ĥ_{q}^{(K)} may be expressed as in Equation 28 below.

$${\hat{H}}_{q}^{( κ )} = {vec}^{- 1} ( α \cdot {[ {F}_{M}^{H} {F}_{M} {C}_{R} R {Φ}^{\hat{κ}} {F}_{N} ]}_{q} ) \qquad [ Equation 28 ]$$

a may be equal to Equation 29 for least square channel estimation and may be equal to Equation 30 for minimum mean square error channel estimation.

$$α = 1 / {\overline{x}}_{q} \qquad [ Equation 29 ]$$

$$α = {\overline{x}}_{q}^{*} / ( {\vert {\overline{x}}_{q} \vert}^{2} + {n}_{0} ) \qquad [ Equation 30 ]$$

X̅_{q} may be a channel estimate of a signal or symbol allocated to the q-th delay-Doppler domain resource. no may be a variance of noise or an average noise power. q may be a one-dimensional resource index of the signal or symbol for channel estimation in the delay-Doppler domain. The q-th one-dimensional input delay-Doppler domain resource index may correspond to the (└(q−1)/M┘+1)-th input Doppler resource and the (((q−1) mod M)+1)-th input delay resource of the estimation resource index starting from 1.

[A]_{q} may be the q-th column of a matrix A. [A]_{m,n} may be an element of the m-th row and n-th column of the matrix A. vec⁻¹(a) may mean de-vectorization of a vector a, and vec(vec⁻¹(a)) may be a.

Sₖ, which is a set of candidates for the fractional part of Doppler shift may be expressed as in Equation 31 below.

$${S}_{κ} = \{ κ : κ = {Δ}_{κ} \cdot k for k ∈ [ - ( {N}_{κ} - 1 ) / 2 , ( {N}_{κ} - 1 ) / 2 ] \} \qquad [ Equation 31 ]$$

Nₖ may be the number of candidates for the fractional part of Doppler shift. Δₖ may be 1/Nₖ, which is a step size of the candidates of the fractional part of Doppler shift.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM, or flash memory. The program command may include not only machine language codes created by a compiler but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a receiver, comprising:
performing a demodulation process so that a fractional part of a Doppler shift of a received signal is compensated; and
de-spreading the received signal for which the fractional part of the Doppler shift compensated from a first two-dimensional domain to a second two-dimensional domain.

2. The method according to claim 1, wherein the performing of the demodulation process so that the fractional part of the Doppler shift of the received signal is compensated includes:
performing multi-carrier demodulation on multi-carrier symbols of the received signal;
de-mapping spread data symbols from resources for the multi-carrier-demodulated multi-carrier symbols in the first two-dimensional domain; and
compensating for the fractional part of the Doppler shift for each of the spread data symbols to generate each spread data symbol for which the fractional part of the Doppler shift is compensated.

3. The method according to claim 1, wherein the performing of the demodulation process so that the fractional part of the Doppler shift of the received signal is compensated includes:
performing multi-carrier demodulation on multi-carrier symbols of the received signal;
compensating for the fractional part of the Doppler shift for each of the multi-carrier-demodulated multi-carrier symbols to generate each multi-carrier symbol for which the fractional part of the Doppler shift is compensated; and
obtaining each spread data symbol for which the fractional part of the Doppler shift is compensated from resources for the multi-carrier symbols for which the fractional part of the Doppler shift is compensated in the first two-dimensional domain.

4. The method according to claim 1, further comprising:
receiving a reference signal from a transmitter; and
estimating the fractional part of the Doppler shift based on the reference signal,
wherein in the performing of the demodulation process so that the fractional part of the Doppler shift of the received signal is compensated, the receiver compensates for the fractional part of the Doppler shift by using the estimated fractional part of the Doppler shift.

5. The method according to claim 1, further comprising:
transmitting a reference signal to a transmitter;
receiving, from the transmitter, information on the fractional part of the Doppler shift estimated based on the reference signal,
wherein in the performing of the demodulation process so that the fractional part of the Doppler shift of the received signal is compensated, the receiver compensates for the fractional part of the Doppler shift by using the information on the fractional part of the Doppler shift estimated based on the reference signal, which is received from the transmitter.

6. The method according to claim 1, further comprising:
obtaining data symbols by de-mapping de-spread data symbols from resources in the second two-dimensional domain;
performing channel estimation on the data symbols in a delay-Doppler domain; and
performing channel equalization on the data symbols based on the channel estimation.

7. The method according to claim 1, wherein the first two-dimensional domain corresponds to a time-frequency domain, and the second two-dimensional domain corresponds to a delay-Doppler domain.

8. A method of a transmitter, comprising:
mapping data symbols to resources in a first two-dimensional domain;
spreading the data symbols to resources in a second two-dimensional domain so that a fractional part of a Doppler shift for the data symbols is compensated; and
performing multi-carrier modulation on each multi-carrier symbol for the spread data symbols.

9. The method according to claim 8, wherein the spreading of the data symbols to resources in the second two-dimensional domain so that the fractional part of the Doppler shift for the data symbols is compensated includes:
performing preprocessing on the data symbols;
compensating for the fractional part of the Doppler shift for the preprocessed data symbols; and
mapping the data symbols for which the fractional part of the Doppler shift is compensated to the resources in the second two-dimensional domain.

10. The method according to claim 8, wherein the spreading of the data symbols to resources in the second two-dimensional domain so that the fractional part of the Doppler shift for the data symbols is compensated includes:
performing preprocessing on the data symbols;
mapping the preprocessed data symbols to the resources in the second two-dimensional domain; and
compensating for the fractional part of the Doppler shift for the data symbols mapped to the resources in the second two-dimensional domain after the preprocessing.

11. The method according to claim 8, further comprising:
receiving a reference signal from a receiver; and
estimating the fractional part of the Doppler shift based on the reference signal,
wherein in the spreading of the data symbols to resources in the second two-dimensional domain so that the fractional part of the Doppler shift for the data symbols is compensated, the transmitter compensates for the fractional part of the Doppler shift by using the estimated fractional part of the Doppler shift.

12. The method according to claim 8, further comprising:
transmitting a reference signal to a receiver; and
receiving, from the receiver, information on the fractional part of the Doppler shift, which is estimated based on the reference signal,
wherein in the spreading of the data symbols to resources in the second two-dimensional domain so that the fractional part of the Doppler shift for the data symbols is compensated, the transmitter compensates for the fractional part of the Doppler shift by using the information on the estimated fractional part of the Doppler shift, which is received from the receiver.

13. The method according to claim 8, wherein the first two-dimensional domain corresponds to a time-frequency domain, and the second two-dimensional domain corresponds to a delay-Doppler domain.

14. A receiver comprising a processor,
wherein the processor causes the receiver to perform;
performing a demodulation process so that a fractional part of a Doppler shift of a received signal is compensated; and
de-spreading the received signal for which the fractional part of the Doppler shift compensated from a first two-dimensional domain to a second two-dimensional domain.

15. The receiver according to claim 14, wherein in the performing of the demodulation process so that the fractional part of the Doppler shift of the received signal is compensated, the processor causes the receiver to perform:
performing multi-carrier demodulation on multi-carrier symbols of the received signal;
obtaining spread data symbols from resources for the multi-carrier-demodulated multi-carrier symbols in the first two-dimensional domain; and
compensating for the fractional part of the Doppler shift for each of the spread data symbols to generate each spread data symbol for which the fractional part of the Doppler shift is compensated.

16. The receiver according to claim 14, wherein in the performing of the demodulation process so that the fractional part of the Doppler shift of the received signal is compensated, the processor causes the receiver to perform:
performing multi-carrier demodulation on multi-carrier symbols of the received signal;
compensating for the fractional part of the Doppler shift for each of the multi-carrier-demodulated multi-carrier symbols to generate each multi-carrier symbol for which the fractional part of the Doppler shift is compensated; and
obtaining each spread data symbol for which the fractional part of the Doppler shift is compensated from resources for the multi-carrier symbols for which the fractional part of the Doppler shift is compensated in the first two-dimensional domain.

17. The receiver according to claim 14, wherein the processor causes the receiver to perform:
receiving a reference signal from a transmitter; and
estimating the fractional part of the Doppler shift based on the reference signal,
wherein in the performing of the demodulation process so that the fractional part of the Doppler shift of the received signal is compensated, the processor further causes the receiver to compensate for the fractional part of the Doppler shift by using the estimated fractional part of the Doppler shift.

18. The receiver according to claim 14, wherein the first two-dimensional domain corresponds to a time-frequency domain, and the second two-dimensional domain corresponds to a delay-Doppler domain.
